(19) United States
(12) Patent Application Publication
(10) Pub. No.: US 2012/0129058 A1
(43) Pub. Date: May 24, 2012

(54) Electrical Energy Storage Device

(76) Inventors: Kevin P. Litzinger, Level Green, PA (US); Wolfgang Drenckhahn, Erlangen (DE); Nicolas Vortmeyer, Erlangen (DE); Shailesh D. Vora, Monroeville, PA (US); Wolfgang Menapace, Erlangen (DE)

(21) Appl. No.: 12/953,553

(22) Filed: Nov. 24, 2010

(51) Int. Cl. H01M 12/04

(52) U.S. Cl. 429/403

(57) ABSTRACT

An electrical energy storage device is provided which comprises at least one module with an anode, a cathode made from an anion generating material or material combination and conducting anions, and an anion conducting solid electrolyte located between the anode and the cathode. The anode of each module comprises a porous structure that conducts anions and is infiltrated by a liquid infiltration mass which comprises a metal in a non-oxidised and/or in an oxidised state.

### FIELD OF THE INVENTION

The present invention relates to an electrical energy storage device comprising at least one module with an anode, a cathode, and an anion conducting electrolyte located between the anode and the cathode.

### BACKGROUND OF THE INVENTION

High temperature solid oxide electrolyte fuel cells are well known in the art and convert chemical energy into direct current electrical energy, typically at temperatures above about 500° C. This temperature is required to render the solid electrolyte sufficiently conductive. Stabilized zirconia is a prime electrolyte. Such fuel cells are taught, for example, by U.S. Pat. No. 4,395,468 (Isenberg). The general working principles and general reactions of a solid oxide fuel cell (“SOFC”) are shown in prior art FIG. 1, which is self-explanatory. Air and a required gaseous fuel, such as natural gas, are both utilized solely to generate electricity at about 800° C. to about 1,000° C. This type SOFC utilizes metal/ceramic fuel electrodes 10, gaseous reformed natural gas fuel and ceramic, dense solid electrolyte 11 and porous ceramic air electrode 12. No metals are used as only ceramics or metal ceramics can withstand these high temperatures. Fuel 13 is shown by F and oxidant or air A is shown by 14.

An encyclopedic publication by N. Q. Minh, in Ceramic Fuel Cells, J. Am. Ceramic Soc., 76[3] 563-588, 1993 describes in detail a variety of fuel cell designs, including tubular, triangular and other configurations, as well as materials used and accompanying electrochemical reactions. For example, that article describes segmented cell-in-series (banded and bell-and-spigot), monolithic (co-flow and cross-flow), and flat-plate designs in substantial detail. Cermet fuel electrode (anode) materials, such as nickel or cobalt/yttria stabilized zirconia are also discussed as well as their coefficient of thermal expansion problems.

In addition to generating energy, batteries also store it. Electrical energy storage is crucial for the effective proliferation of an electrical economy and for the implementation of many renewable energy technologies. During the past two decades, the demand for the storage of electrical energy has increased significantly in the areas of portable, transportation, and load-levelling and central backup applications. The present electrochemical energy storage systems are simply too costly to penetrate major new markets, still higher performance is required, and environmentally acceptable materials are preferred. Transformational changes in electrical energy storage science and technology are in great demand to allow higher and faster energy storage at the lower cost and longer lifetime necessary for major market enlargement. Most of these changes require new materials and/or innovative concepts with demonstration of larger redox capacities that react more rapidly and reversibly with cations and/or anions.

Batteries are by far the most common form of storing electrical energy, ranging from: standard every day lead—acid cells, exotic iron-silver batteries for nuclear submarines taught by Brown in U.S. Pat. No. 4,078,125 and nickel-metal hydride (NiMH) batteries taught by Venkatesan et al. in U.S. Pat. No. 5,856,047, Kitayama in U.S. Pat. No. 6,399,247 B1 and Young et al. in U.S. Pat. No. 7,261,970. Also known are metal-air cells taught in U.S. Pat. No. 3,977,901 (Buzzelli), Isenberg in U.S. Pat. No. 4,054,729, U.S. Patent Publications 2006/0063051; 2007/0077491; 2007/0259234 (Jang, Burchardt and Chua et al, respectively) and air batteries also taught in U.S. Patent Publications 2003/0143457 and 2004/0241537 (Kashino et al. and Okuyama et al., respectively). Lithium-ion batteries are taught by Ohata in U.S. Pat. No. 7,396,612 B2. These latter metal-air, nickel-metal hydride and lithium-ion battery cells require liquid electrolyte systems.

Batteries range in size from button cells used in watches, to megawatt loading levelling applications. They are, in general, efficient storage devices, with output energy typically exceeding 90% of input energy, except at the highest power densities. Rechargeable batteries have evolved over the years from lead-acid through nickelcadmium and nickel-metal hydride (NiMH) to lithium-ion. NiMH batteries were the initial workhorse for electronic devices such as computers and cell phones, but they have almost been completely displaced from that market by lithium-ion batteries because of the latter's higher energy storage capacity. Today, NiMH technology is the principal battery used in hybrid electric vehicles, but it is likely to be displaced by the higher power energy and now lower cost lithium batteries, if the latter's safety and lifetime can be improved. Of the advanced batteries, lithium-ion is the dominant power source for most rechargeable electronic devices.

### SUMMARY OF THE INVENTION

With respect to the mentioned prior art it is an objective of the present invention to provide an advantageous electrical energy storage device that can easily discharge and charge a high capacity of energy quickly and reversibly, as needed.

This objective is solved by an electrical energy storing device as claimed in the independent claim. The depending claims define further developments of the invention.

An inventive electrical energy storage device comprises at least one module with an anode, a cathode made from an anion generating material, or material combination, that conduct anions and electrons, and an anion conducting solid electrolyte located between the anode and cathode. The anode of each module comprises a porous structure, typically a porous ceramic structure, that conducts anions and is at least partially infiltrated by a liquid infiltration mass, which comprises a metal in a non-oxidised and/or in an oxidised state or which comprises a metal in a first oxidised state and/or in a second oxidised state. Preferably the porous ceramic structure also conducts electrons.

Such an electrical energy storage device can easily discharged by oxidising the metal of the infiltration mass (or by further oxidising the metal in the first oxidised state) and charged by applying a voltage between the anode and the cathode that leads to desoxidising of the oxidised metal (or the metal in the second oxidised state) in the infiltration mass. Note, that the electrical polarities of the anode and the cathode may change, depending on whether the electrical storage device is discharged or charged.

In particular, the metal in at least one of said oxidised states can be an oxide of the metal, i.e. an oxygen compound of said metal. Note, that in a more general sense, the metal in the oxidised state may be represented by other compounds in which the metal donates one or more electrons to another element of the compound. For example, an element of the halogen group could be used for oxidising the metal so that a metal halogenide compound would be formed. However, oxygen is a preferred element for oxidising the metal in the infiltration mass since oxygen is easily available from air and metal oxides are typically non-toxic.

The infiltration mass is preferably liquid at temperatures above 500° C., in particular at temperatures between 600° C. and 800° C. As these temperatures, high ion transport capacities of the solid electrolyte can be achieved.

In a special implementation of the liquid infiltration mass the metal as such is liquid at temperatures below 800° C. Metals fulfilling this condition are, e.g. tin, lead, bismuth and thallium. However, other metals liquid below 800° C. for example, Gallium, Zinc, Cadmium or Mercury are in general also suitable as a metal that is liquid at temperatures below 800° C.

In a different implementation, in which the metal is not itself liquid at temperature below 800° C. the infiltration mass can comprise a molten salt of said metal comprised in the infiltration mass. By this measure, a mixture of the metal and the metal salt can be achieved that is liquid even at temperatures at which the metal itself would not be liquid. The molten salt can, for example, comprise chlorine as an anion. In this case, the infiltration mass maybe formed by a mixture given by the formula:

aMe-bMe₂O₃-MeClₓ

where a+b+c=1.

Suitable metals which are liquid in a liquid mass comprising a salt of the respective metal, in particular of the form MeClₓ, are iron or nickel. Those amounts of the metal which are not bound in the salt compound are then available for oxidising and desoxidising.

A suitable geometrical configuration oft the at least one module is a tubular configuration in which the module extends along a longitudinal axis and has a circular cross section with the cathode at the inside of the circle and the anode at the outside of the circle. The module then further comprises an internal channel that extends along the longitudinal direction and is surrounded by the cathode, and an outer casing surrounding the anode and forming a container for the liquid infiltration mass. This container has openings connecting the air channel to the ambient air at least at one end of the tube, preferably at both ends so that an unhindered air flow through the air channel can be realised. Alternatively, in the tubular configuration, the cathode can be at the outside of the tubular module. The anode is then located inside of the tubular module. In this case, the inside can be hermetically sealed so as to form the container for the liquid infiltration mass. A container surrounding the outside of the tube is than not necessary since the outside shall be exposed to ambient air so that oxygen for producing oxygen ions is available.

Other configurations of the at least one module of the electrical energy storage device are possible as well. For example, flat configurations in which a number of flat modules can be stacked and in which each module comprises a layer stack with a cathode, an anode and an electrolyte located between the cathode and the anode together with air channels leading along or through the cathode. Generally the electrical contacting of a tubular cell is more difficult compared with a flat cell. Therefore, the flat configuration is advantageous.

To increase the voltage produced by the electrical energy storage device at least two modules can be connected in serious. Similarly, to increase the current of the electrical energy storage device at lest two modules can be connected in parallel. Connecting modules in parallel and in series is also possible.

In an inventive electrical energy storage device at least one air channel may be present for leading air to the electrical modules. Moreover, the cathodes in such an electrical energy storage device are then located in the air channel so as to allow for guiding air along the cathodes.

### BRIEF DESCRIPTION OF THE DRAWINGS

Further features, properties and advantages of the present invention will become clear from the following description of embodiments in conjunction with the accompanying drawings.

FIG. 1 illustrates the working principals of prior art SOFC's;

FIG. 2 illustrates the broadest example of the energy storage device of this invention based on an anion A conductor which utilizes A-containing gas and eliminates the need for gaseous fuel;

FIG. 3 illustrates the working principals of one embodiment of the electrical energy storage device of this invention, which utilizes air and eliminates the need for gaseous fuel;

FIG. 4 illustrates an example of both electrode reactions of the electrical energy storage device of this invention;

FIG. 5 schematically shows a typical tubular configuration of the electrical energy storage device with an inner cathode in a sectional view along the longitudinal direction of the cell;

FIG. 6 schematically shows a typical tubular configuration of the electrical energy storage device with an outer cathode in a sectional view along the longitudinal direction of the cell;

FIG. 7 perceptively shows a typical tubular configuration of the electrical energy storage device with an inner cathode in a sectional view along the radial direction of the cell;

FIG. 8 perceptively shows a further typical tubular configuration of the electrical energy storage device with an inner cathode in a sectional view along the radial direction of the cell;

FIG. 9 perceptively shows a typical tubular configuration of the electrical energy storage device with an outer cathode in a sectional view along the radial direction of the cell;

FIG. 10 shows an electrical energy storage device formed of three banks each comprising a number of tubular cell modules.

FIG. 11 schematically shows a typical flat configuration of the electrical energy storage device in a sectional view.

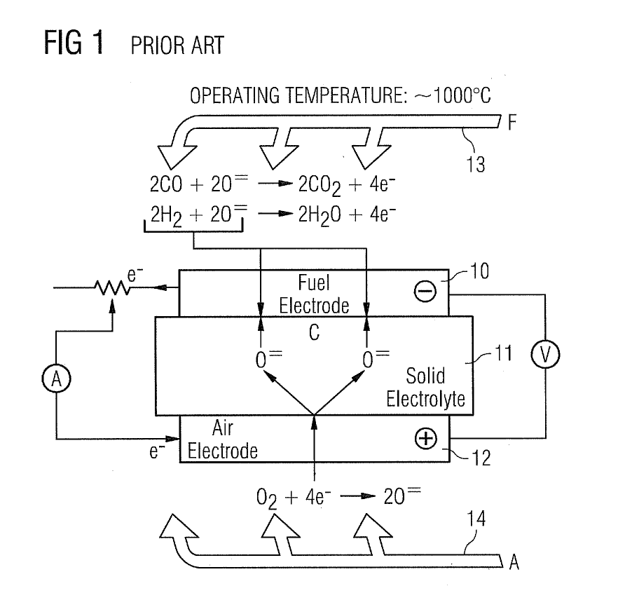

### DETAILED DESCRIPTION OF THE INVENTION

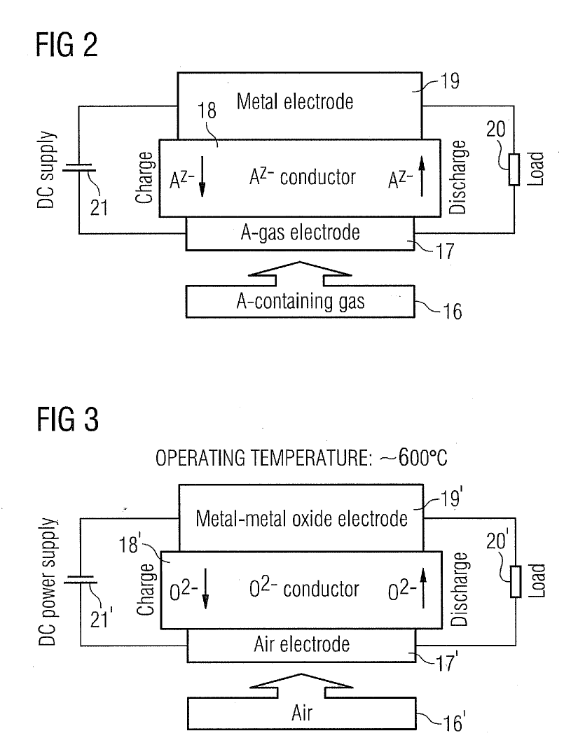

The broadest working principle of the electrical storage device of this invention is shown in FIG. 2. A non-fuel containing gas 16 which contains an anion forming element or compound A contacts an A-gas electrode 17 made from a material or material composition that generates and conducts anions from the element or compound A. An anion A^{z-} conducting conductor/electrolyte 18 is disposed next to the A-gas electrode and an electron conducting electrode 19. Furthermore, there is an electrical circuit, a load 20 and a DC supply 21. Here, there is an anion A^{z-} conducting electrolyte where there is ion transfer between electrodes on either side of the electrode, such ions are selected from at least one of O²⁻, CO²⁻, S²⁻, PO₄³⁻, I⁻, F⁻, and Cl⁻.

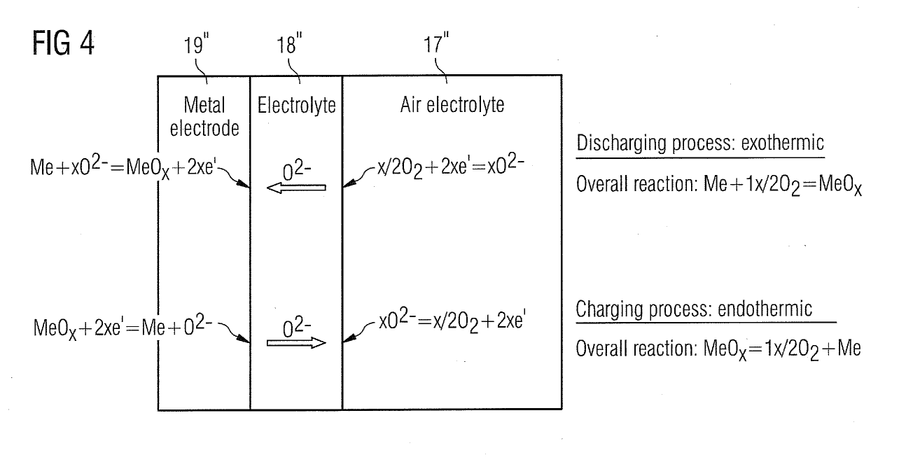

The working principle of one embodiment of the electrical storage device of this invention is schematically shown in FIG. 3. In this embodiment, the A-gas is air with oxygen (O) as the anion forming element. Hence, FIG. 3 shows an oxide-ion battery configuration. In discharge mode, oxide-ion anions migrate from high partial pressure of oxygen side (air side in this case) to low partial pressure of oxygen side (metal-metal oxide electrode) under the driving force of gradient of oxygen chemical potential. In charge mode, the oxide-ions are forced to migrate from low partial pressure of oxygen side to high partial pressure of oxygen side under the driving force of electrical field. Here, air 16′ contacts air electrode (cathode) 17′. Oxygen ion conductor electrolyte is between the air electrode and metallic (metal-metal oxide) electrode (anode) 19′. Load is shown as 20′, and D.C. power supply 21′. The corresponding electrode reactions occurring during charge and discharge course are illustrated in FIG. 4. Under the discharge mode the metal of the anode is oxidized into metal oxide with exothermic heat whereas under the charge mode metal oxide of the anode is reduced into metal with endothermic heat. The discharging process is, where Me stand for metal:

yMe+x/2O₂=Me_{y}Oₓ,

and the charging process is:

Me_{y}Oₓ=x/2O₂+yMe,

where x/y is preferably from 0.5 to 3.0. Here, air electrode is shown as 17″, electrolyte as 18″ and metal electrode as 19″.

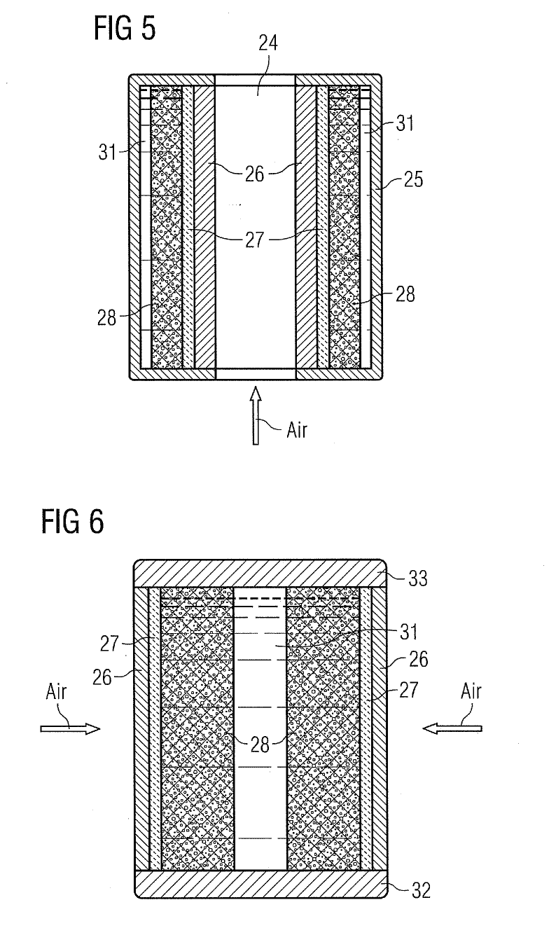

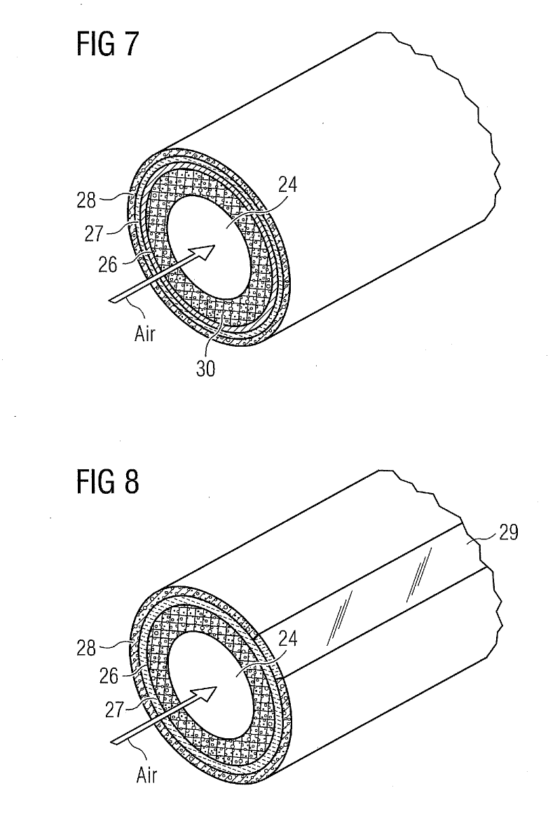

Tubular cell configurations are preferred and will be illustrated throughout this specification for simplicity reasons. However, this should not be construed in any way as restrictive, as other “hollow, elongated tubular cell” structures are herein included, as are described by Isenberg, in U.S. Pat. No. 4,728,584—a corrugated design, and by U.S. Patent Application Publication No. U.S. 2008/0003478 A1 (Greiner et al.)—a triangular, quadrilateral, oval, stepped triangle and meander, are all herein defined as “hollow elongated tubular” cells. Typical tubular cell configurations are schematically displayed in FIGS. 5 to 9 in sectional views along the longitudinal direction (FIGS. 5 and 6) and perspective views in a section along the radial direction (FIGS. 7 to 9).

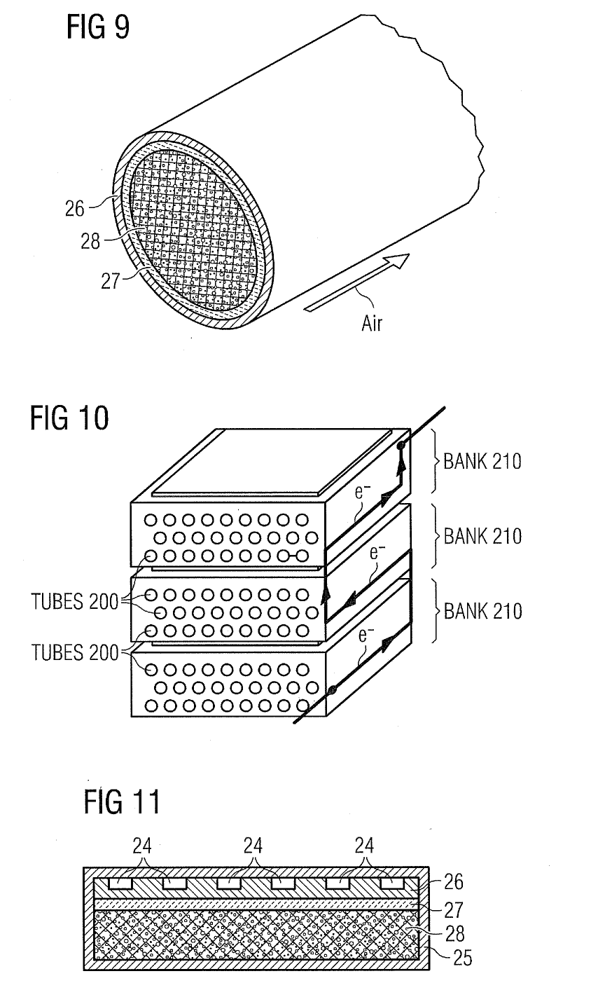

The cell configurations comprise at least three functional layers: an air electrode (cathode) 26, a solid electrolyte 27 and an anode 28. While FIGS. 5, 7 and 8 show cell configurations with an inner cathode 26, an inner air channel 24 and an outer casing 25 forming a container, FIGS. 6 and 9 show cell configurations with an outer cathode 26.

In the cell configuration with the inner cathode 26 and the air channel 24, oxidant air is fed to the inner surface of the cathode trough the air channel 24, which is open at both axial ends of the tubular cell. Note, that in any case no fuel gas is used, only air. In the cell configuration with the inner cathode 26 and the inner air channel 24, an inner porous metal substrate 30 (see FIG. 7) surrounding the air channel 24 may be present onto which at least one layer of the cathode forming material is applied. The porous metal substrate 30 can be comprised, e.g., of ferritic stainless steel containing mainly Fe, Cr and Mn metal and minor additives such as Ti, Nb, Zr, Ce, La and Y. The porous metal substrate 30 can be replaced by a porous cathode. In this case, a ceramic interconnection strip 29, e.g. comprising or consisting of Ca-doped LaCrO₃ or the like, is present on the elongated tubular surface (see FIG. 8).

In the cell configurations with the outer air-electrode layer (cathode), as shown in FIGS. 6 and 9, the anode 28 may be in the form of a Structure forming the centre of the cell. The anode 28 can have circular, square, irregular or any other cross-section, thus the term structure as used herein shall not be restricted to circular cross-sections as they are shown in FIGS. 6 and 9. The anode 28 then forms a substrate for the electrolyte and air electrode layers that are sequentially deposited on the anode. In this design, an outer casing is no longer necessary. Only two axial and plates 32, 33 seal the cell configuration.

In the cell configuration shown in FIGS. 5 and 6, measures are taken in order to assure that the casing 25 or the sealing plates 32, 33 do not provide a short circuit between the anode 28 and the cathode 26. Such a measure can be, e.g., that the casing itself is isolating and includes contact elements which allow to electrically contact the anode 28 and the cathode 26. Another such measure can be, e.g., that the container 25 or each plate 32, 33 is composed of two parts where on of those parts only contacts the anode 26 while the other part only contacts the cathode 28 with both parts being electrically isolated against each other or with the electrolyte extending into the casing or the plates so as to separate both parts from each other.

Both cell configurations, i.e., the cell configuration with the inner air-electrode layer and the cell configuration with the outer air-electrode layer, the air electrode layer (cathode) 26 comprises an OTM (oxygen transporting material), in particular, a material selected from the group comprising perovskite (ABO₃), scandia-doped zirconia (also called scandia stabilised zirconia ScSZ), yttria-doped zirconia (also called yttria stabilised zirconia YSZ) and combinations thereof. For example, in the present embodiment the cathode 26 comprises a two-phase mixture of electronic conducting phase LaMnO₃-based perovskites, in particular Ca-doped LaMnO₃, and oxide-ion conducting phase scandia-doped Zirconia. However, in addition, or as an alternative, to LaMnO₃-based perovskites the cathode of the present embodiment can comprise other doped and undoped oxides or mixtures of oxides in the perovskite family, such as CaMnO₃, LaNiO₃, LaCoO₃, LaCrO₃ doped with conducting mixed oxides of rare earth and/or oxides of Co, Ni, Cu, Fe, Cr, Mn and their combinations.

The electrolyte layer is a dense ceramic membrane that transfers oxygen ions (O²) and can comprise, or consist of, a single ceramic phase that conducts anions, e.g. a single phase of scandia stabilised zirconia. As an alternative, yttria stabilised zirconia or mixtures of scandia stabilised zirconia and yttria stabilised zirconia could be used instead of scandia stabilised zirconia. The electrolyte layer is typically about 20 micrometers to 100 micrometers thick.

The most important component of the cell of this invention is the anode 28. Important criteria for the anode 28 are: thermodynamic EMF (electromotive force); theoretical energy density (MJoule/kg metal); thermodynamic electrical efficiency; cost ($/kWatt electrical hours eh) [e=electricity; h=hour]; maximum current density (determines performance); and maximum charge storage (ampere hour/cm²).

According to the present invention, the anode 28 is formed from a porous structure that conducts anions and, in the present embodiment, also electrons. The porous structure is infiltrated by an electron conducting liquid infiltration mass which comprises a metal in a non-oxidised and/or in an oxidised state. The porous structure (skeleton) is formed from a perovskite (ABO₃). In the present embodiment, the porous structure is formed from a mixture of LaCrO₃ doped with Strontium (Sr) and/or Cobalt (Co) and Gadolinium-doped ceria (GDC). The fraction of GDC may very from 30% to 70%. Preferably, the porous structure is formed from a mixture that consist of 50% by weight doped LaCrO₃ and 50% by weight GDC. A technique available to form a fine porous structure (also called skeleton) is, for example, plasma spraying to form a well-adhered fine structured mixed electrical conducting skeleton.

The porous ceramic structure is infiltrated with an infiltration mass that is liquid at temperatures above 500° C., in particular at temperatures between 600° C. and 800° C.

In a first embodiment of the infiltration mass, the mass is formed by liquid tin/tin oxide (Sn/SnOₓ). However, other metals that are liquid at temperatures below 800° C. like, for example, lead (Pb), bismuth (Bi) and thallium (Ti) can also be used in their oxidised and/or non-oxidised form. The liquid metal in the oxidised and/or non-oxidised state infiltrates the porous structure which has a large surface. Hence, the metal/metal oxide has a large interface to the ion and electron leading porous ceramic structure, which allows a quick loading and a high current of the electrical energy storage device.

In an alternative embodiment of the liquid infiltration mass, the mass is formed by a molten salt that comprises a metal in an oxidised and/or in an non-oxidised state together with a salt of this metal. The salt forming element can be a halogen, in particular chlorine (Cl). Such an infiltration mass can be represented by the formula

aMe-bMe₂O₃-MeClₓ with a+b+c=1.

The metal used in the molten salt is chosen such that the molten salt with the metal and/or the metal oxide is liquid at temperatures below 800° C., in particular in the temperature range between 600° C. and 800° C. In the present embodiment iron (Fe) is used as metal Me in the molten salt which fulfils the above conditions. An alternative element fulfilling these conditions would be nickel (Ni).

A cell as described above can itself form an electrical energy storage device. However, a cell can also be used as module in an electrical storage device. Two or more such modules can be connected in series to increase the available voltage or in parallel to increase the available current. In addition, it is possible to form banks, where each bank comprises at least two modules that are connected in parallel to increase the available current. An electrical energy storage device can then comprise two or more such banks that are connected in series to increase the available voltage. An electrical energy storage device formed of three banks 210 each comprising a number of tubular cells 200 as modules is shown in FIG. 10.

There are many advantages presented by a bank of cells to provide a consolidated oxide-ion battery:
1) The cell bank and module system can be much simplified. Since no gaseous fuels are used, the relevant subsystems of SOFC's, such as reformer, desulfurizer and depleted fuel recirculation loop can be eliminated, resulting in considerable cost reduction. In addition, common combustion of depleted fuel and vitiated air encountered in a SOFC is no longer present. Therefore, the system reliability is also greatly improved.
2) Doubly charged oxide-ion enables the highest theoretical energy density among the existing electrical storage devices.
3) Most metal-metal oxide systems in oxide-ion battery are superior in performance to materials used in lithium-ion battery.
4) Faster charging and discharging rates that are thermally activated by elevated temperature operation.
5) Reversible Redox reaction at elevated temperatures ensures prolonged lifetime and minimum energy loss during each storage cycle.

Up to now only a tubular configuration of the modules of the electrical energy storage device has been described. However, as already mentioned before other configurations are possible is well. For example, FIG. 11 shows a flat configuration in a schematic sectional view. The flat electrical energy storage device module of the present embodiment is formed from three layers stacked onto each other, namely an anode (26), a cathode (air-electrode) (28) and a solid electrolyte located between the anode and the cathode and separating them from each other. One side of the cathode (26) is provided with notches (24) forming air channels when the hole layer stack is encased by an outer casing (25). To allow air for entering the air channels formed by the notches (24) the notches extend to the casing wall and the casing wall is open where the notches reach the casing wall.

What has been said with respect to the materials the cathode (26), the electrolyte (27) and the anode (28) are made of in the tubular configuration is also valid in the embodiment shown in FIG. 11. In particular, the porous anode (28) is infiltrated by a liquid mass as it has been described with respect to the tubular configuration.

It should be mentioned that FIG. 11 depicts only one example of a flat configuration. Modifications to the flat configuration shown in FIG. 11 are possible. For example, while the anode is the lowermost layer and the cathode the uppermost layer of the layer stack shown in FIG. 11 it is also possible to have the anode as the uppermost layer and the cathode as the lowermost layer. In addition, the air channel configuration may differ from what is shown in FIG. 11. For example, it is possible not to form notches in the cathode layer but to arrange for a space between the anode and the casing wall so that a flat air channel is formed between the casing wall and the cathode. However, a space between the cathode and casing wall may also be combined with forming notches in the anode so as to increase the anode surface.

Like with the tubular configuration the modules in the flat configuration can be connected in series and/or in parallel. Moreover, the modules of the flat configurations can be piled.

The invention described above provides for an electrical energy storage device that can easily discharge and charge a high capacity of energy quickly and reversibly, as needed. In addition, the electrical energy storage device is simple, can operate for years without major maintenance and does not need to operate on carbonaceous fuel gases such as natural gas fuel, hydrocarbon fuel or its reformed by-products such as H₂ fuel. Moreover, the invention allows for a simple cell and module structure with high theoretical energy density, low system cost, and low power-loss current collection.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

1. An electrical energy storage device, comprising:
a module comprising:
an anode;
a cathode made from an anion generating material or material combination and conducting anions; and
an anion conducting solid electrolyte located between the anode and the cathode,
wherein the anode comprises a porous structure that conducts anions and is at least partially infiltrated by a liquid infiltration mass comprising a metal in a non-oxidised and/or in an oxidised state or comprising a metal in a first oxidised state and/or in a second oxidised state.

2. The electrical energy storage device as claimed in claim 1, wherein the metal in the oxidised states is an oxide of the metal.

3. The electrical energy storage device as claimed in claim 1, wherein the liquid infiltration mass is liquid at temperatures above 500° C.

4. The electrical energy storage device as claimed in claim 3, wherein the liquid infiltration mass is liquid at a temperature between 600° C. and 800° C.

5. The electrical energy storage device as claimed in any of the claim 1, wherein the metal is liquid at temperatures below 800° C.

6. The electrical energy storage device as claimed in claim 5, wherein the metal is selected from the group consisting of: tin, lead, bismuth, and thallium.

7. The electrical energy storage device as claimed in any of the claim 1, wherein the liquid infiltration mass comprises a molten salt of the metal.

8. The electrical energy storage device as claimed in claim 7, wherein the molten salt comprises chlorine as an anion.

9. The electrical energy storage device as claimed in claim 8, wherein the liquid infiltration mass is formed by a mixture given by the formula:
aMe-bMe₂O₃-MeClₓ
where a+b+c=1.

10. The electrical energy storage device as claimed in claim 9, wherein Me stands for iron or nickel.

11. The electrical energy storage device as claimed in claim 1,
wherein the module has a tubular configuration that extends along a longitudinal axis,
wherein the tubular configuration has a circular cross section with the cathode at an inside and the anode at an outside, and
wherein the tubular configuration comprises an internal air channel that extends along the longitudinal axis and is surrounded by the cathode and an outer casing surrounding the anode.

12. The electrical energy storage device as claimed in claim 1, which the module has a tubular configuration with the cathode at an outside and the anode at an inside.

13. The electrical energy storage device as claimed in claim 1, wherein the module has a flat configuration with a layer stack comprising a cathode layer, an anode layer and a solid electrolyte layer located between the cathode layer and the anode layer.

14. The electrical energy storage device as claimed in claim 1, further comprising at least two modules connected in series.

15. The electrical energy storage device as claimed in claim 14, wherein the at least two modules are connected in parallel.
